(19) United States
(12) Patent Application Publication
(10) Pub. No.: US 2025/0200644 A1
(43) Pub. Date: Jun. 19, 2025

(54) RETAILER LINKED DIALOGUES: CHATTING, CARTING, AND CARING

(71) Applicant: YE Ventures, LLC, Baltimore, MD (US)

(72) Inventors: Jia XU, Hoboken, NJ (US); João Luis LINS, Jersey City, NJ (US)

(73) Assignee: YE Ventures, LLC, Baltimore, MD (US)

(21) Appl. No.: 18/780,139

(22) Filed: Jul. 22, 2024

Related U.S. Application Data
(60) Provisional application No. 63/515,024, filed on Jul. 21, 2023.

(51) Int. Cl. G06Q 30/0601

(52) U.S. Cl. CPC G06Q 30/0641; G06Q 30/0623; G06Q 30/0631

(57) ABSTRACT

Provided is a deep learning method with improved search and dialogue properties connecting. The method includes using, via a model, search engines to look for external and factual knowledge across the internet, finding relevant content for any product's aspect, such as price, reviews, and features; and completing the process of fusing the retrieved knowledge with the dialogue history in order to provide the final response. The using, finding, and completing to connect the Alexa socialbot with the Amazon Store, opening novel functions like better recommendations, conversational shopping guidance, automatic seeking of new product types, and personalization.

### CROSS-REFERENCE TO RELATED APPLICATIONS

This application claims benefit to U.S. Provisional Patent Application No. 63/515,024, filed Jul. 21, 2023, the disclosure of which is incorporated herein in its entirety, by reference.

### FIELD OF TECHNOLOGY

The present disclosure relates to conversational agents integrated with online retail platforms for enhanced user interaction and personalized shopping experience.

### BACKGROUND

Chatbots currently used in online retail environments often perform limited tasks, such as answering frequently asked questions. These chatbots lack the capability to provide meaningful product recommendations due to their restricted data, which is typically confined to a user's previous purchases within a specific store. This limitation results in a fragmented and impersonal user experience.

Existing e-commerce chatbots struggle to understand complex user demands and cannot correlate requests with contextual information. This shortcoming leads to basic product listings rather than tailored recommendations. Additionally, these chatbots are not equipped to handle specific user requirements, such as budget constraints or particular product features. There is a need for a more advanced conversational agent that can offer a seamless and personalized shopping experience by integrating comprehensive product knowledge and user profiling.

### SUMMARY

Given the aforementioned deficiencies, there is a critical need for a deep learning method with improved search and dialogue properties.

According to one aspect of the present disclosure, a deep learning method with improved search and dialogue properties connects, comprising using, via a model, search engines to look for external and factual knowledge across the internet; finding relevant content for any product's aspect, such as price, reviews, and features; and completing the process of fusing the retrieved knowledge with the dialogue history to provide the final response; wherein the using, finding, and completing to connect the Alexa socialbot with the Amazon Store, opening novel functions like better recommendations, conversational shopping guidance, automatic seeking of new product types, and personalization.

The embodiments provide a chapter not only how an individual feels but also understands their needs. How convenient would it be if it could recommend a variety of new things you would love to have but did not know about? For example, the socialbot could connect to the Amazon Store and conversationally arrange all aspects of the buying process (budget, description, decision, payment, and shipping).

Embodiments of the disclosure connect systems, such as Amazon purchasing with social bot devices, such as Alexa, to provide more successful user chatting and shopping experiences. Through complete understanding and gentle asking, our bot makes users feel cared for with reminders like “It is raining heavily outside, do you need a raincoat?”

The embodiments provide a model that facilitates a system with knowledge about all products, describing them in a conversational way while understanding complex aspects of a demand to provide accurate suggestions for each use case, just like a professional shopping guide does. The system satisfies the demand for the purchasing experience to not be not fragmented and to feel personal to buy something in this manner. The embodiments develop a deep learning methodology with improved search and dialogue properties and facilitated by advanced training and decoding methods. Also provided is dialogue that models specific user profiling and large language modeling techniques.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 is a comparison between current Alexa's model a model constructed in accordance with the embodiments.

FIG. 2 is an exemplary model architecture in accordance with the embodiments.

FIG. 3 is a block diagram of an exemplary computing device configured for implementing one or more embodiments of the present disclosure.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

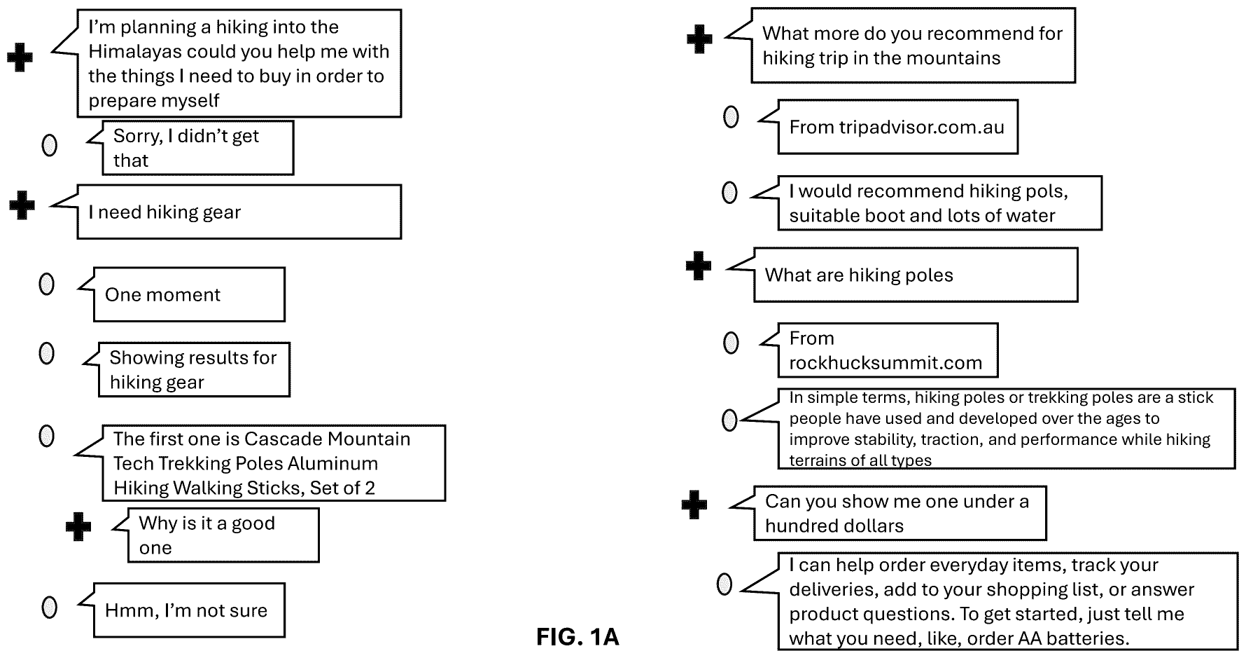

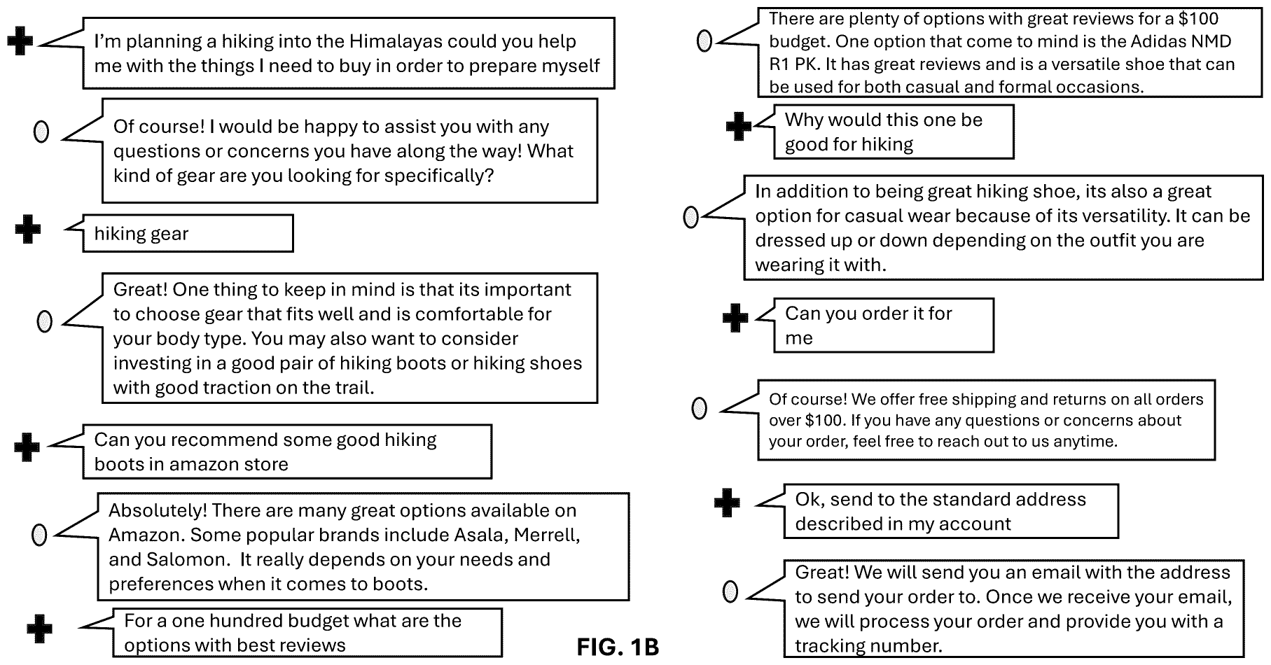

There are three types of chatbots: Artificial intelligence (AI) driven, Rules-based, and Hybrid. Although chatbots, such as Giosg, Chatfuel and Bostify, are already used in a variety of online stores, they can perform only shallow tasks related to FAQs. Even worse, they are not able to provide good recommendations because their data is limited to what the user has already purchased in a specific store. Conversely, a native conversational bot, associated with an excellent user profile, would be able to identify more assertively what the user needs while conducting the entire buying process in a natural way. As an example, follows a comparison between the current Alexa implementation and a model's, FIG. 1.

While a plethora of models [References #2, 3, 5, 8-11] have been proposed to improve the bot conversation quality, despite some improvements, today's e-commerce chatbot techniques are still far from being practically useful, posing the following new technical challenges:

Fluent, natural, and memorable conversation. During multiple bot conversations, users constantly discuss their buying needs, believing that the bot can deliver good insights about products that fit into their needs. We need to remember users' past conversations and response fluently and naturally.

Recommendation for new products with specific requirements. The existing e-commerce chatbots are only able to understand straightforward demands and cannot correlate the request associated context, resulting in a product listing, and not an actual recommendation. Additionally, they cannot filter the results on specific requirements such as budget or other particular required aspects. Lastly, the user experience is fragmented and impersonal.

Broadening domains. We believe that a socialbot should be able to discuss all sorts of domains. Hence, we need a learning-based chatbot that is adaptable and portable for a range of unseen shopping domains.

Knowledge of products. A perfect model should facilitate the system with knowledge about all products, describing them in a conversational way while understanding complex aspects of a demand in order to provide accurate suggestions for each use case, just like a professional shopping guide does.

Personalization. There is high demand for the purchasing experience to not be not fragmented and to feel personal to buy something in this manner.

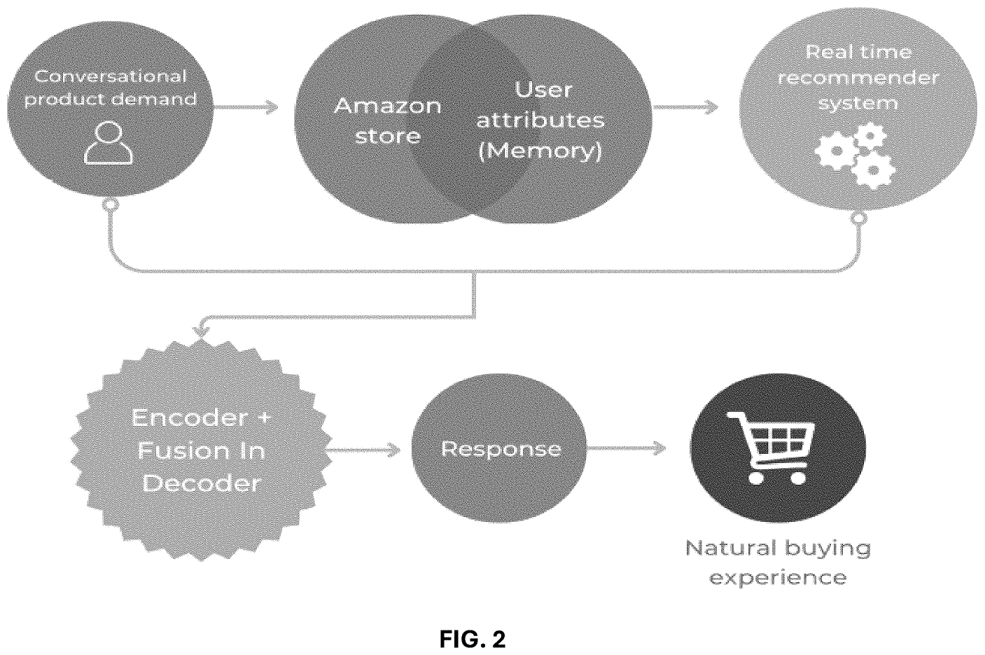

This project develops a deep learning methodology with improved search and dialogue properties. FIG. 2 illustrates our model architecture, facilitated by advanced training and decoding methods with dialogue that models specific user profiling and large language modeling techniques. Our approach integrates chatting with the shopping experience across domains seamlessly. Specifically, we address four research areas:

### 1.1 Large Language Models

Our approach makes the whole buying process seem like a social conversation, where inputs are slowly fed into the model's context. It uses a pretrained large language model to provide important contextual information.

### 1.2 Fine-Tuning and Decoding

After fine-tuning Blenderbot 3 [7] on retailing-based conversational data [1], we could already simulate natural conversation samples to support the idea. Not only is the result a more comfortable experience, but our social bot opens the margin for new products to be bought, enlarging the market venue.

### 1.3 User Profile and Knowledge Database

BlenderBot 3 [7] implements Seeker [6], a model that excels at using search engines to look for external and factual knowledge across the internet. In this sense, our system can readily find relevant content for any product's aspect, such as price, reviews, and features. Finally, we rely on Seeker's modular approach to complete the process of fusing the retrieved knowledge with the dialogue history in order to provide the final response. Using the Fusion In Decoder method as described in [4], we are able to increase the factualness of the recommendations while maintaining the usual diverse neural generation of the responses.

### 1.4 Integrate Purchasing History in Chat

After helping the user to order products, our approach memorizes the experience to predict better future responses and recommendations.

### 1.5 Evaluation and Risk Analysis

A detailed risk analysis must be performed to assert the accuracy and relevance of each recommendation, moreover a continuous track of post selling has to be integrated into the system in order to reduce future dissatisfaction by the user-side. These post selling data can be fed in the recommendation model using a reinforcement learning approach.

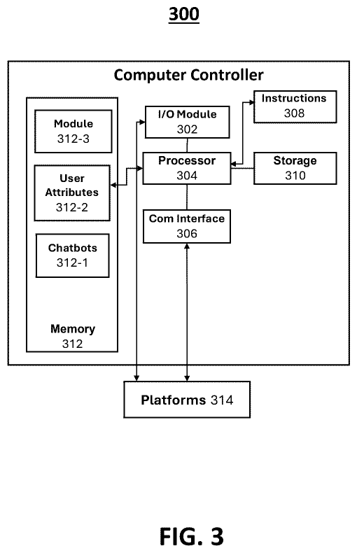

In the embodiments, FIG. 3 illustrates a computer controller 300 that may be an application-specific hardware, software, and firmware implementation of the mainframe pipeline processes depicted in FIGS. 1-2, described above. The controller 300 may include a processor 304 configured to be executed on one or more, or all the blocks of the system of FIGS. 1-2, described above.

The processor 304 can have a specific structure imparted to the processor 304 by instructions stored in the memory 312 and/or by instructions 308 fetchable by the processor 304 from a storage medium 310. The storage medium 310 can be remote and communicatively coupled to the controller 300.

The controller 300 can be a stand-alone programmable system, or a programmable module included in a larger system. For example, the controller 300 may include or be connected with external computer systems. For example, the controller 300 may include one or more hardware and/or software components configured to fetch, decode, execute, store, analyze, distribute, evaluate, and/or categorize information.

The processor 304 may include one or more processing devices or cores (not shown). In some embodiments, the processor 304 may be a plurality of processors, each having one or more cores. The processor 304, in another embodiment, may be a distributed processor. The processor 304 can execute instructions fetched from the memory 312, i.e., with reference to, among other code, instructions or data, one of memory modules 312-1, 312-2, or 312-3. Alternatively, the instructions can be fetched from the storage medium 310, or from a remote device connected to the controller 300 via the communication interface 306.

Furthermore, the communication interface 306 can also interface with processors within a computer system of the mainframe pipeline architecture. An input/output (I/O) module 302 may be configured for additional communications to or from associated local and/or remote systems of one or more platforms 314, such as the mainframe pipeline process of FIGS. 1-3.

Without loss of generality, the storage medium 310 and/or the memory 312 can include a volatile or non-volatile, magnetic, semiconductor, tape, optical, removable, non-removable, read-only, random-access, or any type of non-transitory computer-readable computer medium. The storage medium 310 and/or the memory 312 may include programs and/or other information usable by processor 304. Furthermore, the storage medium 310 can be configured to log data processed, recorded, or collected during the operation of the controller 300.

The data may be time-stamped, location-stamped, cataloged, indexed, encrypted, and/or organized in a variety of ways consistent with data storage practice. The memory modules in memory 312 may represent specialized modules for various functions described in the embodiments herein.

By way of example, the memory module 312-1 may represent a specialized module configured to implement aspects of the chatbots as described above. Similarly, the memory module 312-2 may form a user attributes module, as described with reference to one or more of FIGS. 1-3, described above. The instructions embodied in these memory modules can cause the processor 304 to perform certain operations consistent with the functions described above.

The processor 304 is a hardware device for executing software, particularly that stored in memory 312. The processor 304 can be any custom made or commercially available processor, a central processor unit (CPU), an auxiliary processor among several processors associated with the computer controller 300, a semiconductor based microprocessor (in the form of a microchip or chip set), a macroprocessor, or generally any device for executing software instructions.

The memory 312 can include any one or combination of volatile memory elements (e.g., random access memory (RAM, such as DRAM, SRAM, SDRAM, etc.)) and nonvolatile memory elements (e.g., ROM, erasable programmable read-only memory (EPROM), electronically erasable programmable read-only memory (EEPROM), programmable read-only memory (PROM)).

Memory 312 may also include removable storage such as tape, compact disc read-only memory (CD-ROM), disk, diskette, cartridge, cassette or the like, etc., and non-removable storage such as a hard disk drive (HDD).

Moreover, the memory 312 may incorporate electronic, magnetic, optical, and/or other types of storage media. Note that the memory 312 can have a distributed architecture, where various components are situated remote from one another, but can be accessed by the processor 304.

The software in memory 312 may include one or more separate programs, each of which comprises an ordered listing of executable instructions for implementing logical functions, and a suitable operating system (OS). The OS essentially controls the execution of the computer programs, and provides scheduling, input-output control, file and data management, memory management, and communication control, and related services.

If the computer controller 300 is a PC, workstation, intelligent device or the like, the software in the memory 312 may further include a basic I/O system (BIOS), omitted from this description for simplicity. The BIOS is a set of essential software routines that initialize and test hardware at startup, start the OS, and support the transfer of data among the hardware devices. The BIOS is stored in read-only memory (ROM) so that the BIOS can be executed when the computer controller 300 is activated.

The embodiments provide integration of advanced deep learning methodologies with conversational agents to enhance the e-commerce shopping experience. Specifically, the disclosure introduces the following aspects:

1. Comprehensive Product Knowledge Integration: Unlike existing chatbots that rely on limited data confined to a user's previous purchases within a specific store, this disclosure uses search engines to look for external and factual knowledge across the internet. This allows the chatbot to find relevant content for any product's aspect, such as price, reviews, and features, thereby providing more accurate and comprehensive recommendations.

2. Fusion of Retrieved Knowledge with Dialogue History: The disclosure completes the process of fusing the retrieved knowledge with the dialogue history to provide the final response. This ensures that the recommendations are not only accurate but also contextually relevant, enhancing the overall user experience.

3. Enhanced Personalization and User Profiling: The disclosure leverages advanced training and decoding methods to model specific user profiling and large language modeling techniques. This allows the chatbot to offer personalized shopping guidance, automatic seeking of new product types, and tailored recommendations based on individual user needs and preferences.

4. Seamless Integration with E-commerce Platforms: The disclosure connects the Alexa socialbot with the Amazon Store, opening novel functions like better recommendations, conversational shopping guidance, and personalization. This seamless integration ensures that the entire buying process, from budget considerations to payment and shipping, can be managed conversationally, making the shopping experience more natural and user-friendly.

5. Continuous Learning and Improvement: The disclosure incorporates mechanisms for continuous learning and improvement, such as integrating purchasing history in chat and performing detailed risk analysis to assert the accuracy and relevance of each recommendation. This ensures that the chatbot continually evolves to meet user needs more effectively.

These novel aspects collectively address the limitations of existing e-commerce chatbots, providing a more seamless, personalized, and effective shopping experience.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

References include:
[1] Nolwenn Bernard and Krisztian Balog. Mg-shopdial: A multi-goal conversational dataset for ecommerce. In Proceedings of the 46th International ACM SIGIR Conference on Research and Development in Information Retrieval (SIGIR '23), Jul. 23-27, 2023, Taipei, Taiwan, SIGIR '23, 2023.
[2] Mikhail Burtsev, Alexander Seliverstov, Rafael Airapetyan, Mikhail Arkhipov, Dilyara Baymurzina, Nickolay Bushkov, Olga Gureenkova, Taras Khakhulin, Yuri Kuratov, Denis Kuznetsov, Alexey Litinsky, Varvara Logacheva, Alexey Lymar, Valentin Malykh, Maxim Petrov, Vadim Polulyakh, Leonid Pugachev, Alexey Sorokin, Maria Vikhreva, and Marat Zaynutdinov. DeepPavlov: Open-source library for dialogue systems. In Proceedings of ACL 2018, System Demonstrations, pages 122-127, Melbourne, Australia, July 2018. Association for Computational Linguistics.
[3] Lei Cui, Shaohan Huang, Furu Wei, Chuanqi Tan, Chaoqun Duan, and Ming Zhou. SuperAgent: A customer service chatbot for E-commerce websites. In Proceedings of ACL 2017, System Demonstrations, pages 97-102, Vancouver, Canada, July 2017. Association for Computational Linguistics.
[4] Gautier Izacard and Edouard Grave. Leveraging passage retrieval with generative models for open domain question answering, 2021.
[5] Jiawei Liu, Zhe Gao, Yangyang Kang, Zhuoren Jiang, Guoxiu He, Changlong Sun, Xiaozhong Liu, and Wei Lu. Time to transfer: Predicting and evaluating machine-human chatting handoff. Proceedings of the AAAI Conference on Artificial Intelligence, 35 (7): 5841-5849 May 2021.
[6] Kurt Shuster, Mojtaba Komeili, Leonard Adolphs, Stephen Roller, Arthur Szlam, and Jason Weston. Language models that seek for knowledge: Modular search generation for dialogue and prompt completion, 2022.
[7] Kurt Shuster, Jing Xu, Mojtaba Komeili, Da Ju, Eric Michael Smith, Stephen Roller, Megan Ung, Moya Chen, Kushal Arora, Joshua Lane, Morteza Behrooz, William Ngan, Spencer Poff, Naman Goyal, Arthur Szlam, Y-Lan Boureau, Melanie Kambadur, and Jason Weston. Blenderbot 3: a deployed conversational agent that continually learns to responsibly engage, 2022.
[8] Anna Tigunova, Andrew Yates, Paramita Mirza, and Gerhard Weikum. CHARM: Inferring personal attributes from conversations. In Proceedings of the 2020 Conference on Empirical Methods in Natural Language Processing (EMNLP), pages 5391-5404, Online, November 2020. Association for Computational Linguistics.
[9] Zhao Yan, Nan Duan, Peng Chen, Ming Zhou, Jianshe Zhou, and Zhoujun Li. Building task-oriented dialogue systems for online shopping. Proceedings of the AAAI Conference on Artificial Intelligence, 31(1), February 2017.
[10] Riheng Yao, Shuangyong Song, Qiudan Li, ChaoWang, Huan Chen, Haiqing Chen, and Daniel Dajun Zeng. Session-level user satisfaction prediction for customer service chatbot in e-commerce (student abstract). Proceedings of the AAAI Conference on Artificial Intelligence, 34 (10): 13973-13974, April 2020.
[11] WeiSheng Zhang, Kaisong Song, Yangyang Kang, Zhongqing Wang, Changlong Sun, Xiaozhong Liu, Shoushan Li, Min Zhang, and Luo Si. Multi-turn dialogue generation in E-commerce platform with the context of historical dialogue. In Findings of the Association for Computational Linguistics: EMNLP 2020, pages 1981-1990, Online, November 2020. Association for Computational Linguistics.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A deep learning method with improved search and dialogue properties connecting, comprising:
using, via a model, search engines to look for external and factual knowledge across the internet;
finding relevant content for any product's aspect, such as price, reviews, and features; and
completing the process of fusing the retrieved knowledge with the dialogue history in order to provide the final response;
wherein the using, finding, and completing to connect the Alexa socialbot with the Amazon Store, opening novel functions like better recommendations, conversational shopping guidance, automatic seeking of new product types, and personalization.
